(19) United States
(12) Patent Application Publication
(10) Pub. No.: US 2026/0138442 A1
(43) Pub. Date: May 21, 2026

(54) AUXILIARY DRIVING APPARATUS FOR FOUR-WHEEL ELECTRIC VEHICLE

(71) Applicants: HYUNDAI MOTOR COMPANY, Seoul (KR); KIA CORPORATION, Seoul (KR)

(72) Inventors: Jongyun Park, Hwaseong-si (KR); Chonok Kim, Hwaseong-si (KR); Baekyu Kim, Hwaseong-si (KR); Chulmin Ahn, Hwaseong-si (KR); Sung Gon Byun, Hwaseong-si (KR); Won Seok Lee, Hwaseong-si (KR); Junyoung Ha, Hwaseong-si (KR); Su Hyeon Maeng, Hwaseong-si (KR); Dong Hui Cheon, Hwaseong-si (KR); Jieun Kim, Hwaseong-si (KR); Yohan Kim, Hwaseong-si (KR); Jaehyuk Seo, Hwaseong-si (KR); Jongho Jung, Hwaseong-si (KR); Yunkyung Ji, Hwaseong-si (KR); Sun Sung Kwon, Hwaseong-si (KR); Kwang Min Choi, Hwaseong-si (KR)

(73) Assignees: HYUNDAI MOTOR COMPANY, Seoul (KR); KIA CORPORATION, Seoul (KR)

(21) Appl. No.: 19/391,824

(22) Filed: Nov. 17, 2025

(30) Foreign Application Priority Data
Nov. 18, 2024 (KR) 10-2024-0163822

(51) Int. Cl. B60K 17/356; B60K 6/365; B60K 17/34; F16H 37/08

(52) U.S. Cl. CPC B60K 17/356; B60K 6/365; B60K 17/34; F16H 37/0806; B60Y 2200/92

(57) ABSTRACT

An auxiliary driving apparatus of a four-wheel drive (4WD) hybrid electric vehicle is provided. The auxiliary driving apparatus is a series-type driving apparatus to which a longitudinal engine is applied, and a driving mechanism including an engine, a motor, and a plurality of clutches is applied to the front wheel side of a hybrid electric vehicle with a motor applied to the rear wheel side as a main driving source, so that the series mode can be implemented in the rear wheel 2WD mode, and the 4WD (AWD) EV mode can be driven when the engine is stopped.

### CROSS-REFERENCE TO RELATED APPLICATION

This application claims priority to and the benefit of Korean Patent Application No. 10-2024-0163822 under 35 U.S.C. § 119, filed on Nov. 18, 2024, in the Korean Intellectual Property Office, the entire contents of which are incorporated herein by reference.

### FIELD

The present disclosure relates to an auxiliary driving apparatus of a four-wheel drive (4WD) hybrid electric vehicle.

### BACKGROUND

Environment-friendly technology in the vehicle field is a core technology that determines the survival of the future vehicle industry, and vehicle manufacturers are making all-out efforts to develop environment-friendly vehicles to achieve environmental and fuel efficiency regulations.

As part of environment-friendly vehicle, vehicle manufacturers are focusing on developing environment-friendly electric vehicles such as hybrid electric vehicle (HEV), plug-in hybrid electric vehicle (PHEV), pure electric vehicle (BEV: Battery Electric Vehicle), and fuel cell electric vehicle (FCEV).

Because environment-friendly vehicles have various technical constraints such as weight and cost, vehicle manufacturers are paying attention to electric vehicles as a realistic alternative to satisfy exhaust gas regulations and improve fuel efficiency performance, and are also competing fiercely in research and development of power delivery devices to put them into practice.

The information contained in this Background section is intended to promote understanding of the background of the disclosure and may include matters that are not conventional art already known to a person having ordinary skill in the art to which this technology belongs.

### SUMMARY

The present disclosure provides an auxiliary driving apparatus of an electric vehicle for a four-wheel drive (4WD) applied to the front wheel side of a hybrid electric vehicle, which uses a motor applied to the rear wheel side as a main driving source, and a series-type driving apparatus to which a longitudinal engine is applied.

In addition, the present disclosure provides a series type to which a longitudinal engine is applied, and a driving mechanism including an engine, a motor, and a plurality of clutches is applied to the front wheel side of a hybrid electric vehicle with a motor applied to the rear wheel side as a main driving source, so as to enable implementation of a series mode in the rear wheel 2WD mode, and to enable driving in a four-wheel drive (4WD) (AWD) EV mode with the engine stopped, thereby increasing fuel efficiency.

In an embodiment of the present disclosure, an auxiliary driving apparatus for a four-wheel drive (4WD) hybrid electric vehicle may be applied to a front wheel side of a hybrid electric vehicle with a first motor applied to a rear wheel side as a main driving source. An engine and an auxiliary motor may be positioned in the longitudinal direction are applied as an auxiliary driving source. A torque output from the auxiliary motor my be reduced in rotation speed by an auxiliary reducer and a driving torque be transmitted to front wheels on both sides through an auxiliary differential while absorbing a difference in rotation speed. The auxiliary motor may include an auxiliary motor shaft formed as a hollow shaft and arranged to overlap an engine output shaft of the engine without rotation interference.

The auxiliary driving apparatus may include an idle shaft arranged parallel to the engine output shaft, and an output shaft arranged parallel to the idle shaft and power-connected to the auxiliary differential via a front wheel transfer. The auxiliary reducer may include a first speed reducing part that selectively reduces a torque of the engine to the auxiliary motor through the engine output shaft, the idle shaft, and the auxiliary motor shaft, and a second speed reducing part that selectively transmits the torque of the auxiliary motor to the front wheel transfer connected to a differential ring gear of the auxiliary differential through the auxiliary motor shaft, the idle shaft, and the output shaft.

The first speed reducing part may include a first input gear fixedly attached to the engine output shaft, a first idle gear rotatably arranged on the idle shaft and externally engaged with the first input gear, a first clutch that selectively connects the first idle gear to the idle shaft, and a second idle gear which is fixedly attached to the idle shaft and externally engages a second input gear which is fixedly attached to the auxiliary motor shaft.

The first clutch may be a dog clutch disposed between a first clutch dog fixedly attached to the idle shaft and a hub of the first idle gear. The first clutch may be a wet-type clutch disposed between the idle shaft and the first idle gear.

The second speed reducing part may include a second input gear fixedly attached to the auxiliary motor shaft, a second idle gear fixedly attached to the idle shaft and externally engaged with the second input gear, an output gear rotatably arranged on the output shaft and externally engaged with the first idle gear, and a second clutch that selectively connects the output gear to the output shaft.

The second clutch may be a dog clutch disposed between a second clutch dog fixedly attached to the output shaft and a hub of the output gear. The second clutch may be a wet-type clutch configured between the output shaft and the output gear.

The front wheel transfer may be a transfer shaft or a propeller shaft.

In 2WD EV mode (EV1), a power delivery path of the second speed reducing part, through which the torque of the auxiliary motor is transmitted to the front wheel drive shaft, may be blocked, and in 2WD series mode, a power delivery path of the first speed reducing part, through which the torque of the engine is transmitted to the auxiliary motor, may be connected.

A power delivery path of the second speed reducing part, where the torque of the auxiliary motor is transmitted to the front wheel drive shaft, may be connected.

The auxiliary driving apparatus for a 4WD hybrid electric vehicle, of which a first motor applied to a rear wheel side is a main driving source, may include an engine placed in a longitudinal direction on a front wheel side. The auxiliary driving apparatus may further include an auxiliary motor which is arranged in a longitudinal direction on the front wheel side and has an auxiliary motor shaft formed as a hollow shaft and is arranged to overlap an engine output shaft of the engine without rotation interference. The auxiliary driving apparatus may further include an idle shaft arranged parallel to the engine output shaft. The auxiliary driving apparatus may further include an output shaft arranged parallel to the idle shaft and providing power connected to an auxiliary differential via a front wheel transfer. The auxiliary driving apparatus may further include a first input gear fixedly attached to the engine output shaft; a second input gear fixedly attached to the auxiliary motor shaft. The auxiliary driving apparatus may further include a first idle gear rotatably positioned on the idle shaft, selectively connected to the idle shaft via a first clutch, and externally engaged with the first input gear. The auxiliary driving apparatus may further include a second idle gear fixedly attached to the idle shaft and externally engaged with the second input gear. The auxiliary driving apparatus may further include an output gear rotatably positioned on the output shaft, selectively connected to the output shaft via a second clutch, and externally engaged with the first idle gear.

It is to be understood that both the foregoing general description and the following detailed description are exemplary and explanatory and are intended to provide further explanation of the disclosure as claimed.

### BRIEF DESCRIPTION OF THE DRAWINGS

These drawings are intended for reference in explaining various disclosure and therefore should not be interpreted as limiting the technical ideas of the present disclosure to the accompanying drawings.

FIG. 1 is a schematic diagram of an auxiliary driving apparatus of a four-wheel drive (4WD) hybrid electric vehicle according to an embodiment of the present disclosure.

FIG. 2 is a schematic operational chart of driving methods of an auxiliary driving apparatus of a four-wheel drive (4WD) hybrid electric vehicle according to an embodiment of the present disclosure.

FIG. 3 and FIG. 4 are schematic operation state diagrams of an auxiliary driving apparatus of a four-wheel drive (4WD) hybrid electric vehicle in a 2WD series mode and a four-wheel drive (4WD) EV mode according to an embodiment of the present disclosure.

FIG. 5 is a schematic diagram of an auxiliary driving apparatus of a four-wheel drive (4WD) hybrid electric vehicle according to another embodiment of the present disclosure.

FIG. 6 is a schematic diagram of an auxiliary driving apparatus of a four-wheel drive (4WD) hybrid electric vehicle according to another embodiment of the present disclosure.

FIG. 7 is a schematic diagram of an auxiliary driving apparatus of a four-wheel drive (4WD) hybrid electric vehicle according to the other embodiment of the present disclosure.

FIG. 8 is a schematic view of the drive system of a typical serial type four-wheel drive (4WD) hybrid electric vehicle.

### DETAILED DESCRIPTION

Hereinafter, referring to the drawings, the embodiments disclosed in this disclosure are described in detail, but identical or similar components are given the same or similar reference numerals and redundant descriptions thereof are omitted.

When explaining the embodiments disclosed in this disclosure, if it is determined that a detailed description of related known technology may obscure the gist of the embodiments disclosed in this disclosure, the detailed description is omitted. In addition, the attached drawings are only intended to facilitate easy understanding of the embodiments disclosed in this disclosure, and the technical ideas disclosed in this disclosure are not limited by the attached drawings, and should be understood to include all modifications, equivalents, or substitutes included in the spirit and technical scope of the present disclosure.

Terms that include ordinal numbers, such as first, second, etc., may be used to describe various configurations of elements, but the components are not limited by the terms. The terms are used solely to distinguish one component from another.

When a component is said to be “connected” or “combined” to another component, it should be understood that it may be directly connected or connected to that other component, but there may also be other components in between. On the other hand, when a component is said to be “directly connected” or “directly combined” to another component, it should be understood that there are no other components in between.

In this application, it should be understood that terms such as “include” or “have” are intended to specify the presence of a feature, number, step, operation, component, part or combination thereof described in the disclosure, but do not exclude in advance the possibility of the presence or addition of one or more other features, numbers, steps, operations, components, parts or combinations thereof.

Terms such as “unit”, “portion”, “part”, “module”, and “means” described in the disclosure are assigned or used interchangeably only for the convenience of writing the disclosure, and do not have distinct meanings or roles in themselves. Terms such as “unit”, “portion”, “part”, “module”, and “means” described in the disclosure may mean a unit that processes at least one function or operation, and this may be implemented by hardware, software, or a combination of hardware and software.

The terminology used herein is for the purpose of describing particular embodiments only and is not to be limiting of the embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this disclosure, specify the presence of stated features, integers, operations, operations, elements, components or a combination thereof, but do not preclude the presence or addition of one or more other features, integers, operations, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As used herein, the singular forms are intended to include the plural forms as well, unless the context clearly indicates otherwise. As used herein, the term “and/or” includes any one or all combinations of the associated listed items.

Hereinafter, one or more embodiments of the present disclosure will be described in more detail with reference to the accompanying drawings.

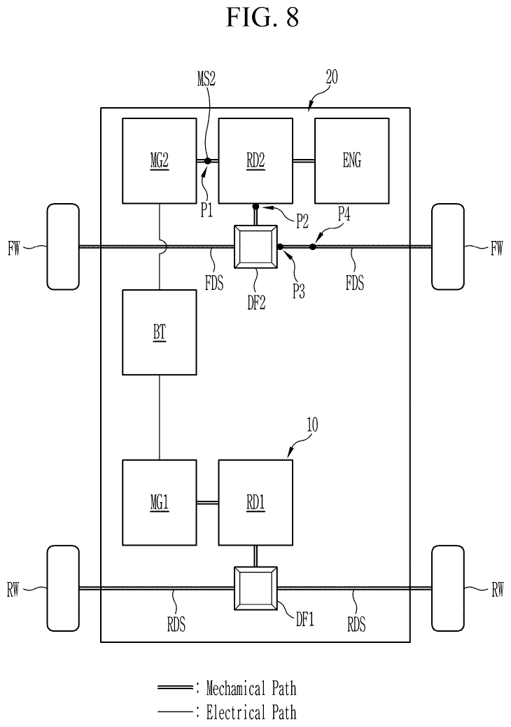

FIG. 8 is a schematic view of the drive system of a typical serial type four-wheel drive (4WD) hybrid electric vehicle.

Referring to FIG. 8, a driving system of a typical four-wheel drive (4WD) hybrid electric vehicle may include a rear wheel side driving apparatus 10 (or a main driving apparatus) including a first motor MG1, a first reducer RD1, and a first differential DF1 disposed on rear wheels RW side and configured to transmit power to the left and right rear wheels RW through left and right rear wheel drive shafts RDS, a front wheel side driving apparatus 20 (or an auxiliary driving apparatus) including an engine ENG, a second motor MG2, a second reducer RD2 disposed between the second motor MG2 and the engine ENG, and a second differential DF2 disposed on front wheels FW side and configured to transmit power to the left and right front wheels FW through left and right front wheel drive shafts FDS, and a battery BT electrically connected to the first and second motors MG1 and MG2 and configured to supply electric power to the first and second motors MG1 and MG2.

The first, second motor MG1, and MG2 may generate output torque by controlling the rotating direction and rotation speed (RPM) by the MCU (Motor Control Unit). The first motor MG1 may provide power to the left and right rear wheels RW, and the second motor MG2 may provide power to the left and right front wheels FW.

These first and second motors MG1 and MG2 may be used as generators to charge battery BT by generating counter electric power when the battery's state of charge (SOC) is low or during regenerative braking.

The first and second reducers RD1 and RD2 may be a type of transmission that reduces rotation speed and transmit the power generated from the first and second motors MG1 and MG2 to the corresponding wheels RW and FW, respectively. The first reducer RD1 may control the rotation speed (or motor torque) of the first motor MG1 and transmit the rotation speed (or motor torque) of the first motor MG1 to the left and right rear wheels RW, and the second reducer RD2 may control the rotation speed (or motor torque) of the second motor MG2 and transmit the rotation speed (or motor torque) of the second motor MG2 to the left and right front wheels FW.

The first and second differentials DF1 and DF2 may be connected to the first and second reducers RD1 and RD2, respectively, and transmit the output torque of the first and second reducers RD1 and RD2 to the corresponding wheels RW and FW. The first reducer RD1 may transmit the power generated from the first motor MG1 while absorbing the difference in rotation speed between the left and right rear wheels RW, and the second reducer RD2 may transmit the power generated from the second motor MG2 while absorbing the difference in rotation speed between the left and right front wheels FW.

The drive system of a four-wheel drive (4WD) hybrid battery vehicle having such a configuration may operate the rear wheel side as the main drive wheel and the front wheel side as the auxiliary drive wheel so that when driving in four-wheel drive (4WD) (or AWD), both the rear wheel side driving apparatus 10 and the front wheel side driving apparatus 20 may be driven to transmit power to both the rear wheel RW and the front wheel FW, and when driving in 2WD, only the rear wheel side driving apparatus 10 may be driven to transmit power to the rear wheel RW, and power may be cut off to the front wheel FW.

The driving system of a typical four-wheel drive (4WD) hybrid electric vehicle illustrated in FIG. 8 is described as a reference for understanding the auxiliary driving apparatus of a four-wheel drive (4WD) hybrid electric vehicle according to one or more embodiments of the present disclosure.

In explaining the auxiliary driving apparatus of a four-wheel drive (4WD) hybrid electric vehicle according to one or more embodiments of the present disclosure, a overlapped explanation of the same configuration as the driving system of a general four-wheel drive (4WD) hybrid electric vehicle illustrated in FIG. 8 is omitted.

Referring to FIG. 8, the front wheel side driving apparatus 20, which is an auxiliary driving apparatus of a four-wheel drive (4WD) hybrid electric vehicle according to an embodiment of the present disclosure, may connect or disconnect power of the second motor MG2 to the left and right front wheels FW through a clutch or the like that functions as a disconnector.

This clutch may be installed on one side P1 of the second motor shaft MS2 to which power of the second motor MG2 is directly transmitted, or on one side P2 of the second reducer RD2, or on one side P3 of the second differential DF2, or on one side P4 of the front wheel drive shaft FDS.

For example, the clutch that performs the function of the disconnector may be installed at four locations, P1, P2, P3, and P4, in the auxiliary driving apparatus (or front wheel side driving apparatus 20) on the front wheel side of the auxiliary driving wheel, and there may be a difference in the power ratio, engage impact, engage time, etc. depending on the installation position.

In particular, in the P1 and P2 positions, there may be no issues with engage impact or engage time, but they may be disadvantageous in terms of power efficiency. On the other hand, in the P3 and P4 positions, they may be advantageous in terms of power efficiency, but there may be issues with engage impact or engage time.

Referring to FIG. 8, an embodiment of the present disclosure is described as an example in which an auxiliary driving apparatus (or front wheel side driving apparatus 20) of a four-wheel drive (4WD) hybrid electric vehicle is applied to a front wheel FW side, which is an auxiliary driving wheel, and a clutch is installed on one side P2 of a second reducer RD2 of the auxiliary driving apparatus (or front wheel side driving apparatus 20) on the front wheel side.

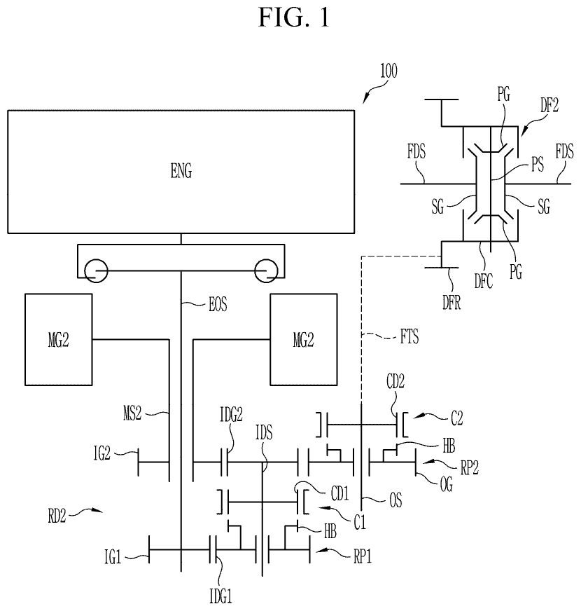

FIG. 1 is a schematic diagram of an auxiliary driving apparatus of a four-wheel drive (4WD) hybrid electric vehicle according to an embodiment of the present disclosure.

Referring to FIG. 1, hereinafter, an auxiliary driving apparatus 100 of a four-wheel drive (4WD) hybrid electric vehicle according to an embodiment of present disclosure is described including all examples in which the auxiliary driving wheel is the front wheel FW, and some components not shown in FIG. 1 are expressed without distinguishing between the front wheel FW side and the rear wheel RW side.

In particular, it is expressed as differential case DFC, differential ring gear DFR, pinion shaft PS, pinion gear PG, side gear SG, etc.

The auxiliary driving apparatus 100 may include a second motor MG2, an engine ENG, a second differential DF2, an idle shaft IDS, an output shaft OS, and a second reducer RD2 including first and second speed reducing parts RP1 and RP2.

In describing the auxiliary driving apparatus 100 according to the embodiment of the present disclosure, a first motor MG1, a first motor shaft MS1, a first reducer RD1, a first differential DF1 are described separately. In the detailed description and claim, second motor MG2, second motor shaft MS2, second differential DF2, and second reducer RD2 may be understood as auxiliary motor, auxiliary motor shaft, auxiliary differential, and auxiliary reducer, respectively.

The engine ENG may be configured as a longitudinally mounted engine placed on the front wheel FW side, which is an auxiliary driving wheel, to provide torque to the second motor MG2.

The second motor MG2 may be arranged in the longitudinal direction on the front wheel FW side, and the second motor shaft MS2 may be formed as a hollow shaft and may be arranged to overlap an engine output shaft EOS of the engine ENG without rotation interference to output torque.

The second differential DF2 may be disposed between the front wheel drive shafts FDS on both sides of the front wheel FW to absorb the difference in rotation speed of the front wheels FW on both sides and transmit the torque of the second motor MG2 to the front wheel drive shafts FDS on both sides.

In particular, the second differential DF2 may transmit the torque input from the second reducer RD2 to a differential ring gear DFR connected to a differential case DFC through a side gear SG that revolves with a pinion gear PG on a pinion shaft PS, through front wheel drive shafts FDS on both sides, to the front wheels FW on both sides. At this time, the differential function may be performed by absorbing the difference in rotation speed of the front wheels FW on both sides by the rotation of the pinion gear PG.

An idle shaft IDS may be arranged parallel to the engine output shaft EOS, and the output shaft OS may be arranged parallel to the idle shaft IDS and may be power-connected to the second differential DF2 via a front wheel transfer FTS.

The front wheel transfer FTS may be a transfer shaft or a propeller shaft.

The second reducer RD2 may include a first speed reducing part RP1 which reduces rotation speed of the torque input from the engine ENG through first and second idle gears IDG1 and IDG2 on the idle shaft IDS which is arranged parallel to the engine output shaft EOS of the engine ENG and outputs the torque to the second motor MG2, and a second speed reducing part RP2 which reduces rotation speed of the torque input from the second motor MG2 through an output gear OG on the output shaft OS which is arranged parallel to the idle shaft IDS and the second idle gear IDG2 and outputs the torque to the second differential DF2.

In particular, the first speed reducing part RP1 may include a first input gear IG1, a first idle gear IDG1, a first clutch C1, and a second idle gear IDG2.

The first input gear IG1 may be fixedly attached to the engine output shaft EOS and rotate together with the engine output shaft EOS, and the first idle gear IDG1 may be rotatably arranged at the idle shaft IDS and externally engage the first input gear IG1.

The first clutch C1 may be configured to selectively connect the first idle gear IDG1 to the idle shaft IDS, and the second idle gear IDG2 may be fixedly attached to the idle shaft IDS and externally engage the second input gear IG2, which is fixedly attached to the second motor shaft MS2.

The first clutch C1 may include a dog clutch disposed between a first clutch dog CD1 fixedly attached to the idle shaft IDS and a hub HB of the first idle gear IDG1.

The gear ratios of first and second input gears IG1 and IG2 may be set to reduce the rotation speed of the torque of the engine ENG and transmit the torque to the second motor MG2 together with the first reduction gear RP1.

The first clutch C1 may be configured on the idle shaft IDS together with the first idle gear IDG1 of the first speed reducing part RP1 to selectively transmit or block the torque of the engine ENG to the second motor MG2.

Hereinafter, the operation of the auxiliary driving apparatus of a four-wheel drive (4WD) hybrid electric vehicle according to an embodiment of the present disclosure is described.

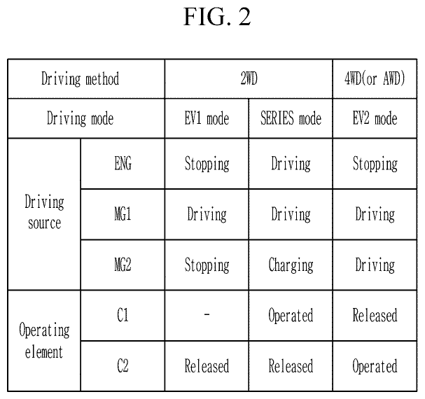

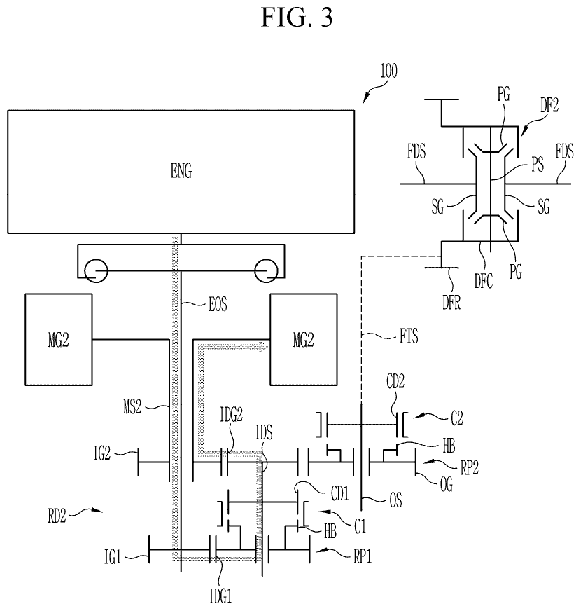

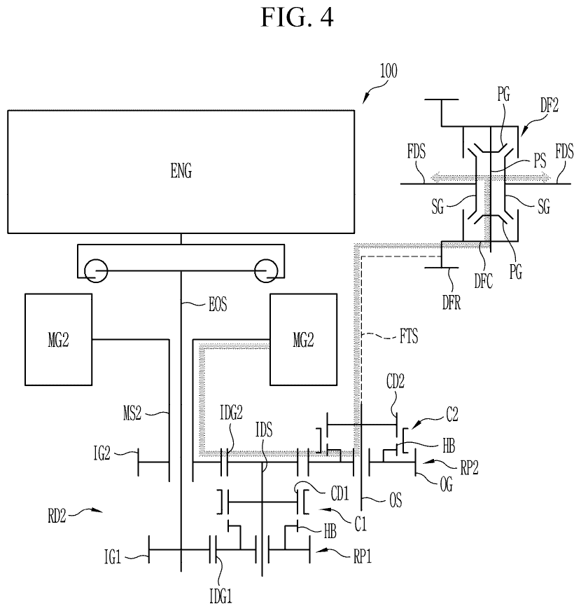

FIG. 2 is a schematic operational chart of driving method of an auxiliary driving apparatus of a four-wheel drive (4WD) hybrid electric vehicle according to an embodiment of the present disclosure. FIG. 3 and FIG. 4 are schematic operation state diagrams of an auxiliary driving apparatus of a four-wheel drive (4WD) hybrid electric vehicle in a 2WD series mode and a four-wheel drive (4WD) EV mode according to an embodiment of the present disclosure.

Before explaining the operation of the auxiliary driving apparatus 100 according to an embodiment of the present disclosure, the auxiliary driving apparatus 100 of the present disclosure is applied and operated on the front wheel FW side, which is an auxiliary driving wheel of a four-wheel drive (4WD) hybrid electric vehicle, and may be divided into 2WD driving and four-wheel drive (4WD) driving depending on the driving method. The auxiliary driving apparatus 100 according to an embodiment of the present disclosure may transmit the torque of the second motor MG2 to the front wheel FW side only when driving in four-wheel drive (4WD), and when driving in 2WD, the power delivery path between the second motor MG2 and the front wheel FW may be blocked by releasing the operation of the disconnector DC, thereby controlling them not to be connected.

### 1. 2WD EV Mode (EV1) Driving

Referring to FIG. 2, when driving in 2WD EV mode EV1, the engine ENG and second motor MG2 on the front wheel FW side may be stopped, the second clutch C2 may be released and the power delivery path through which the torque of the second motor MG2 may be transmitted to the front wheel drive shaft FDS may be blocked.

The first motor MG1 on the rear wheel RW side may drive in the 2WD EV mode (EV1).

It may be advantageous for clutch C to be remained in operation state for the sake of comparison in series mode, regardless of whether it is in operation or not.

### 2. 2WD Series Mode Driving

Referring to FIG. 2 and FIG. 3, in the 2WD series mode, the engine ENG on the front wheel FW may be driven, the second clutch (C2) may remain disengaged in the same manner as in the 2WD EV mode EV1, and the first clutch C1 may operate so that the torque of the engine ENG is transmitted to the first input gear IG1, the first and second idle gears IDG1 and IDG2, and the second input gear IG2. Then, the power delivery path of the first speed reducing part RP1 that reduces the rotation speed of the torque of the engine ENG and transmits the torque to the second motor MG2 on the front wheel FW side may be connected so that the second motor MG2 generates power and charges the battery BT. The first motor MG1 on the rear wheel RW side may operate in 2WD series mode using electricity from the battery BT.

### 3. Four-Wheel Drive (4WD) (or AWD) EV Mode (EV2) Driving

Referring to FIG. 2 and FIG. 4, when driving in four-wheel drive (4WD) (AWD) EV mode (EV2), the engine ENG on the front wheel FW side may stop, the second motor MG2 may be driven, the first clutch C1 may be released from operation, and the second clutch C2 may be operated.

Then, the torque of the second motor MG2 on the front wheel FW side may be transmitted to the second differential DF2 through the second input gear IG2, the second idle gear IDG2, and the output gear OG, and the power delivery path of the second speed reducing part RP2 may be connected to the front wheel transfer FTS, and the driving of the first motor MG1 on the rear wheel RW side may be performed in four-wheel drive (4WD) EV mode EV2.

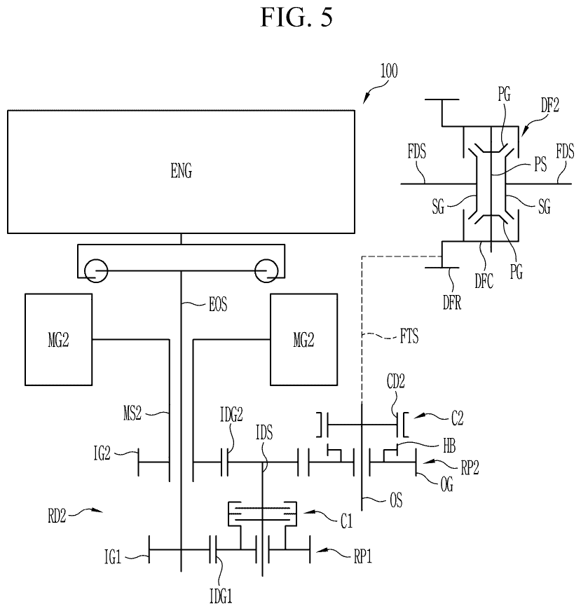

FIG. 5 is a schematic diagram of an auxiliary driving apparatus of a four-wheel drive (4WD) hybrid electric vehicle according to another embodiment of the present disclosure.

Referring to FIG. 5, in another embodiment of the present disclosure, an auxiliary driving apparatus 100 of a four-wheel drive (4WD) hybrid electric vehicle may have a difference in the type of the first clutch C1 compared to the previously disclosed embodiment.

In particular, referring to FIG. 1, the first clutch C1 according to an embodiment of the present disclosure may be configured as a dog clutch disposed between the first clutch dog CD1 fixedly attached to the idle shaft IDS and the hub HB of the first idle gear IDG1, whereas the first clutch C1 according to another embodiment of the present disclosure may be configured as a wet-type clutch operated by hydraulic pressure, with a clutch disk and a clutch plate applied between the idle shaft IDS and the first idle gear IDG1.

Another embodiment of the present disclosure may be different from the previously disclosed embodiment only in the type of the first clutch C1 applied, and the other configurations, operations and effects are the same, and is not described in further detail.

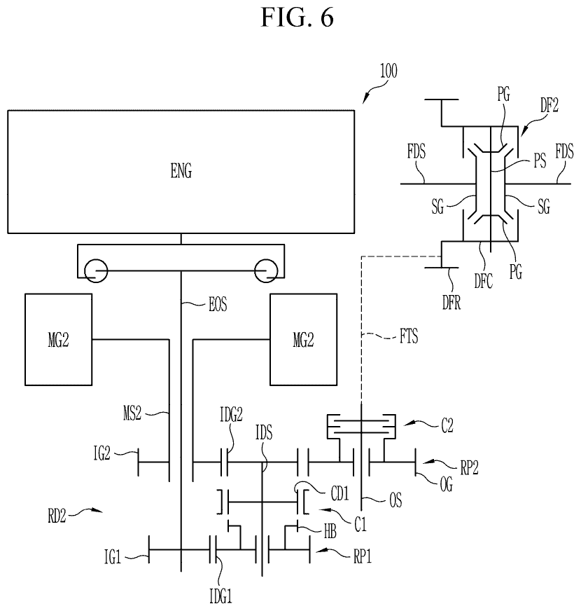

FIG. 6 is a schematic diagram of an auxiliary driving apparatus of a four-wheel drive (4WD) hybrid electric vehicle according to another embodiment of the present disclosure.

In another embodiment of the present disclosure, the auxiliary driving apparatus 100 of a four-wheel drive (4WD) hybrid electric vehicle may have a difference in the type of the second clutch C2 compared to the one embodiment described referring to FIG. 1.

In particular, the second clutch C2 according to an embodiment of the present disclosure may be configured as a dog clutch disposed between the second clutch dog CD2 fixedly attached to the output shaft OS and the hub HB of the output gear OG, whereas the second clutch C2 according to another embodiment of the present disclosure may be configured as a wet-type clutch applied with a clutch disk and a clutch plate between the output shaft OS and the output gear OG and operated by hydraulic pressure.

Thus, another embodiment of the present disclosure may be different only in the type of the second clutch C2 applied compared to the previously disclosed embodiment, and the other configurations, operations and effects are the same, and is not described in further detail.

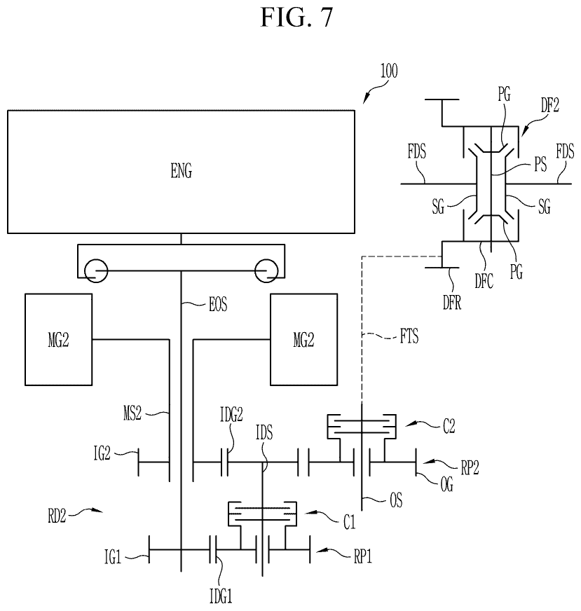

FIG. 7 is a schematic diagram of an auxiliary driving apparatus of a four-wheel drive (4WD) hybrid electric vehicle according to another embodiment of the present disclosure.

In another embodiment of the present disclosure, the auxiliary driving apparatus 100 of a four-wheel drive (4WD) hybrid electric vehicle may have a difference in the types of first and second clutches C1, and C2 compared to the one embodiment described referring to FIG. 1.

In particular, the first clutch C1 according to another embodiment of the present disclosure may be configured with the dog clutch disposed between the first clutch dog CD1 fixedly attached to the idle shaft IDS and the hub HB of the first idle gear IDG1, and the second clutch C2 may be configured with the dog clutch disposed between the second clutch dog CD1 fixedly attached to the output shaft OS and the hub HB of the output gear OG. On the other hand, the first clutch C1 may be formed as a wet-type clutch operated by hydraulic pressure, with a clutch disk and a clutch plate applied between the idle shaft IDS and the first idle gear IDG1, and the second clutch C2 may be formed as a wet-type clutch operated by hydraulic pressure, with a clutch disk and a clutch plate applied between the output shaft OS and the output gear OG.

Thus, another embodiment of the present disclosure may be different only in the types of the first and second clutches C1, and C2 applied compared to the previously disclosed embodiment, and the other configurations, operations and effects are the same, and is not described in further detail.

The auxiliary driving apparatus of a four-wheel drive (4WD) hybrid electric vehicle according to one or more embodiments of the present disclosure may include an engine ENG and the second motor MG2 arranged in a longitudinal direction on the front wheel FW side of a series-type hybrid electric vehicle using the first motor MG1 applied to the rear wheel RW side as a main driving source, the idle shaft IDS and the output shaft OS, and the second reducer RD2 including the first and second speed reducing parts RP1 and RP2, and the first and second clutches C1 and C2, and may be applied as a driving mechanism so that the influence of drag torque generated from the second motor MG2 or the second reducer RD2 can be excluded by releasing the operation of the second clutch C2.

In the auxiliary driving apparatus of a four-wheel drive (4WD) hybrid electric vehicle according to one or more embodiments of the present disclosure, the first clutch C1 may be operated to convert all driving torque generated from the engine

ENG into electricity through the second motor MG2, which is the auxiliary driving source on the front wheel FW side, and then may convert it into power through the first motor MG1, which is the main driving source on the rear wheel RW side, to drive the vehicle, thereby enabling the implementation of a series mode.

In an auxiliary driving apparatus of a four-wheel drive (4WD) hybrid electric vehicle according to the one or more embodiments of the present disclosure, by operating the first and second clutches C1 and C2, it may be possible to increase power efficiency by enabling four-wheel drive (4WD) (AWD) EV mode EV2 driving while the engine ENG is stopped.

Although the present disclosure has been described above with reference to preferred embodiments thereof, it will be understood by those having ordinary skill in the art that various modifications and changes may be made to the present disclosure without departing from the spirit and scope of the present disclosure as set forth in the claims below.

What is claimed is:

1. An auxiliary driving apparatus for a four-wheel drive (4WD) hybrid electric vehicle, which is applied to a front wheel side of a hybrid electric vehicle with a first motor applied to a rear wheel side as a main driving source, an engine and an auxiliary motor positioned in the longitudinal direction are applied as an auxiliary driving source, and a torque output from the auxiliary motor is reduced in rotation speed by an auxiliary reducer and a driving torque is transmitted to front wheels on both sides through an auxiliary differential while absorbing a difference in rotation speed,
wherein the auxiliary motor includes:
an auxiliary motor shaft formed as a hollow shaft and arranged to overlap an engine output shaft of the engine without rotation interference,
wherein the auxiliary driving apparatus includes:
an idle shaft arranged parallel to the engine output shaft; and
an output shaft arranged parallel to the idle shaft and power-connected to the auxiliary differential via a front wheel transfer, and
wherein the auxiliary reducer includes:
a first speed reducing part that selectively reduces a torque of the engine to the auxiliary motor through the engine output shaft, the idle shaft, and the auxiliary motor shaft; and
a second speed reducing part that selectively transmits the torque of the auxiliary motor to the front wheel transfer connected to a differential ring gear of the auxiliary differential through the auxiliary motor shaft, the idle shaft, and the output shaft.

2. The auxiliary driving apparatus of claim 1, wherein the first speed reducing part includes:
a first input gear fixedly attached to the engine output shaft;
a first idle gear rotatably arranged on the idle shaft and externally engaged with the first input gear;
a first clutch that selectively connects the first idle gear to the idle shaft; and
a second idle gear which is fixedly attached to the idle shaft and externally engages a second input gear which is fixedly attached to the auxiliary motor shaft.

3. The auxiliary driving apparatus of claim 2, wherein the first clutch is a dog clutch disposed between a first clutch dog fixedly attached to the idle shaft and a hub of the first idle gear.

4. The auxiliary driving apparatus of claim 2, wherein the first clutch is a wet-type clutch disposed between the idle shaft and the first idle gear.

5. The auxiliary driving apparatus of claim 1, wherein the second speed reducing part includes:
a second input gear fixedly attached to the auxiliary motor shaft;
a second idle gear fixedly attached to the idle shaft and externally engaged with the second input gear;
an output gear rotatably arranged on the output shaft and externally engaged with the first idle gear; and
a second clutch that selectively connects the output gear to the output shaft.

6. The auxiliary driving apparatus of claim 5, wherein the second clutch is a dog clutch disposed between a second clutch dog fixedly attached to the output shaft and a hub of the output gear.

7. The auxiliary driving apparatus of claim 5, wherein the second clutch is a wet-type clutch disposed between the output shaft and the output gear.

8. The auxiliary driving apparatus of claim 1, wherein the front wheel transfer is a transfer shaft or a propeller shaft.

9. The auxiliary driving apparatus of claim 1, wherein
in 2WD EV mode (EV1), a power delivery path of the second speed reducing part, through which the torque of the auxiliary motor is transmitted to the front wheel drive shaft, is blocked, and
in 2WD series mode, a power delivery path of the first speed reducing part, through which the torque of the engine is transmitted to the auxiliary motor, is connected.

10. The auxiliary driving apparatus of claim 1, wherein
a power delivery path of the second speed reducing part, where the torque of the auxiliary motor is transmitted to the front wheel drive shaft, is connected.

11. An auxiliary driving apparatus for a four-wheel drive (4WD) hybrid electric vehicle, of which a first motor applied to a rear wheel side is a main driving source, the auxiliary driving apparatus comprising:
an engine placed in longitudinal direction on a front wheel side;
an auxiliary motor which is arranged in a longitudinal direction on the front wheel side and has an auxiliary motor shaft formed as a hollow shaft and is arranged to overlap an engine output shaft of the engine without rotation interference;
an idle shaft arranged parallel to the engine output shaft;
an output shaft arranged parallel to the idle shaft and providing power connected to an auxiliary differential via a front wheel transfer;
a first input gear fixedly attached to the engine output shaft;
a second input gear fixedly attached to the auxiliary motor shaft;
a first idle gear rotatably positioned on the idle shaft, selectively connected to the idle shaft via a first clutch, and externally engaged with the first input gear;
a second idle gear fixedly attached to the idle shaft and externally engaged with the second input gear; and
an output gear rotatably positioned on the output shaft, selectively connected to the output shaft via a second clutch, and externally engaged with the first idle gear.

12. The auxiliary driving apparatus of claim 11, wherein the first clutch is a dog clutch disposed between a first clutch dog fixedly attached to the idle shaft and a hub of the first idle gear.

13. The auxiliary driving apparatus of claim 11, wherein the first clutch is a wet-type clutch disposed between the idle shaft and the first idle gear.

14. The auxiliary driving apparatus of claim 11, the second clutch is a dog clutch disposed between a second clutch dog fixedly attached to the output shaft and a hub of the output gear.

15. The auxiliary driving apparatus of claim 11, wherein the second clutch is a wet-type clutch disposed between the output shaft and the output gear.

16. The auxiliary driving apparatus of claim 11, wherein the front wheel transfer is a transfer shaft or a propeller shaft.

17. The auxiliary driving apparatus of claim 11, wherein
in 2WD EV mode (EV1), a power delivery path of the second speed reducing part, through which the torque of the auxiliary motor is transmitted to the front wheel drive shaft, is blocked, and
in 2WD series mode, a power delivery path of the first speed reducing part, through which the torque of the engine is transmitted to the auxiliary motor, is connected.

18. The auxiliary driving apparatus of claim 11, wherein
a power delivery path of the second speed reducing part, where the torque of the auxiliary motor is transmitted to the front wheel drive shaft, is connected.

19. The auxiliary driving apparatus of claim 11, wherein the first clutch selectively connects the first idle gear to the idle shaft.

20. The auxiliary driving apparatus of claim 11, wherein the second clutch selectively connects the output gear to the output shaft.
